(19) United States
(12) Patent Application Publication
(10) Pub. No.: US 2010/0130218 A1
(43) Pub. Date: May 27, 2010

(54) METHOD AND APPARATUS FOR SUPPORTING AGGREGATION OF MULTIPLE COMPONENT CARRIERS

(75) Inventors: Guodong Zhang, Syosset, NY (US); Peter S. Wang, East Setauket, NY (US); Ulises Olvera-Hernandez, Kirkland (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/621,910

(22) Filed: Nov. 19, 2009

Related U.S. Application Data
(60) Provisional application No. 61/116,846, filed on Nov. 21, 2008.

(51) Int. Cl. H04W 72/04; H04W 68/00

(52) U.S. Cl. 455/450; 455/458

(57) ABSTRACT

A method and apparatus for supporting aggregation of multiple component carriers are disclosed. A wireless transmit/receive unit (WTRU) in an idle state performs a cell search to detect a downlink anchor carrier and camps on the downlink anchor carrier. The downlink anchor carrier is a component carrier and may be assigned for synchronization and idle mode operations for the WTRU. The WTRU via the downlink anchor carrier receives a broadcast channel for a broadcast message, a paging channel for a paging message, and a control channel for control information necessary while in the idle state. The WTRU receives data via an aggregated carrier having at least two component carriers including a data carrier. The data carrier being a component carrier assigned for data transfer to the WTRU in a connected state.

### CROSS REFERENCE TO RELATED APPLICATIONS

This application claims the benefit of U.S. provisional application No. 61/116,846 filed Nov. 21, 2008, which is hereby incorporated by reference.

### TECHNOLOGY FIELD

This application is related to wireless communications.

### BACKGROUND

Wireless communication systems keep evolving to meet the needs for providing continuous and faster access to a data network. In order to meet these needs, wireless communication systems may use multiple carriers for the transmission and/or reception of data. A wireless communication system that uses multiple carriers for the transmission and/or reception of data may be referred to as a multi-carrier system.

A multi-carrier system may increase the bandwidth available in a wireless communication system according to how many carriers are made available. For example, a dual carrier system may double the bandwidth when compared to a single carrier system and a tri-carrier system may triple the bandwidth when compared to a single carrier system, etc. In addition to this throughput gain, diversity and joint scheduling gains may also be expected. This may improve the quality of service (QoS) for end users. Further, the use of multiple carriers may be used in combination with multiple-input multiple-output (MIMO).

By way of example, to possibly improve achievable throughput and coverage of long term evolution (LTE)-based radio access systems and yet meet the IMT-Advanced requirements of 1 Gbps and 500 Mbps in the downlink (DL) and uplink (UL) directions, respectively, LTE-Advanced (LTE-A) may be considered.

One of the features of the LTE-A is the support of wider radio bandwidth to a wireless transmit/receive unit (WTRU) than in an LTE cell (i.e., LTE Release 8 (LTE-8) cell). It is expected in LTE-A that several frequency carriers (called “component carriers” in LTE-A) may be aggregated up to 100 MHz. This is called spectrum aggregation or carrier aggregation for an LTE-A cell or a carrier set. FIG. 1 shows carrier aggregation in an LTE-A cell or a carrier set. In FIG. 1, the LTE-A cell or carrier set is configured with five component carriers, and these component carriers may be aggregated for wider bandwidth transmissions.

### SUMMARY

A method and apparatus for supporting aggregation of multiple component carriers are disclosed. A WTRU may perform a cell search to detect a downlink anchor carrier and camps on the downlink anchor carrier in an idle state. The downlink anchor carrier is a component carrier assigned for synchronization and idle mode operations for the WTRU among a plurality of component carriers. The WTRU via the downlink anchor carrier receives a broadcast channel for a broadcast message, a paging channel for a paging message, and a control channel for control information necessary while in the idle state. The WTRU may receive data via aggregated carriers comprising at least two component carriers including a data carrier for the peak traffic condition. The data carrier may be a component carrier assigned for data transfer to the WTRU in a connected state.

The WTRU may transmit a random access message via an uplink anchor carrier, and receive a random access response message via the downlink anchor carrier. The WTRU may receive all system information or system information necessary for cell access and idle mode operation via the downlink anchor carrier, and receive system information necessary for connected mode operation via another component carrier. Alternatively, the WTRU may receive system information necessary for cell access and scheduling information for acquiring the rest of the system information via the downlink anchor carrier, and receive system information necessary for idle mode operation and connected mode operation via another component carrier. For co-located LTE cell and an LTE-A carrier, an indication of such co-location may be given to WTRUs.

### BRIEF DESCRIPTION OF THE DRAWINGS

A more detailed understanding may be had from the following description, given by way of example in conjunction with the accompanying drawings wherein:

FIG. 1 shows carrier aggregation in an LTE-A cell (i.e., a carrier set);

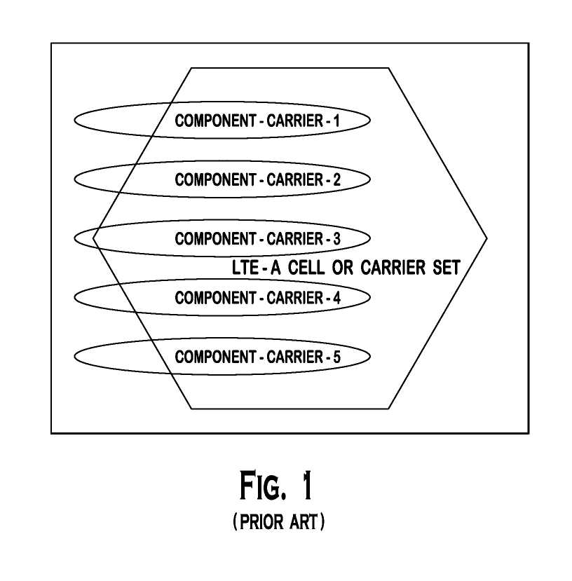

FIG. 2 shows an example LTE wireless communication system/access network that includes an Evolved-Universal Terrestrial Radio Access Network (E-UTRAN);

FIG. 3 is an example block diagram of an LTE wireless communication system including the WTRU, the eNB, and the MME/S-GW; and

FIG. 4 shows component carriers configured as either anchor or data carrier in accordance with one embodiment.

### DETAILED DESCRIPTION

When referred to hereafter, the terminology “WTRU” includes but is not limited to a user equipment (UE), a mobile station, a fixed or mobile subscriber unit, a pager, a cellular telephone, a personal digital assistant (PDA), a computer, a machine-to-machine (M2M) device, a sensor, or any other type of device capable of operating in a wireless environment. When referred to hereafter, the terminology “Node-B” or “eNB” includes but is not limited to a base station, a site controller, an access point (AP), or any other type of interfacing device capable of operating in a wireless environment.

The network may assign at least one downlink and/or at least one uplink carrier as an anchor downlink carrier and an anchor uplink carrier, respectively. In multi-carrier operation a WTRU may be configured to operate with two or more carriers (also referred to as frequencies). Each of these carriers may have distinct characteristics and logical association with the network and the WTRU, and one or more of the operating frequencies may be assigned to as an “anchor carrier” or a “data carrier.” The terminologies “primary carrier” may be used instead of “anchor carrier.” If more than two carriers are configured the WTRU may contain more than one anchor carrier. The anchor carrier may be defined based on any criteria. For example, the anchor carrier may be the component carrier that is assigned for cell search and synchronization. The data carrier is used for higher throughput user data traffic when the WTRU is in a connected state with the network.

The embodiments described hereafter may be used individually or in combination with other embodiments. It should be understood that even though the embodiments disclosed below are described in terms of LTE and LTE-A, the embodiments may be applied to any type of wireless communication systems, both cellular and non-cellular wireless systems, that are currently existing or that will be developed in the future.

When referred to hereafter, the terminology “LTE-A WTRU” refers to a WTRU capable of supporting the LTE-A features including carrier aggregation for simultaneous reception and/or transmission via multiple component carriers, while the terminology “LTE WTRU” or “LTE-8 WTRU” refers to a WTRU built according to pre LTE-A releases that does not have such capability. When referred to hereafter, the terminology “LTE-A cell” refers to a cell comprising a set of component carriers and capable of supporting the LTE-A features including carrier aggregation for simultaneous transmission and/or reception via multiple component carriers, while the terminology “LTE cell” or “LTE-8 cell” refers to a cell comprising only one carrier and does not have such carrier aggregation capability but supports LTE Release 8 only.

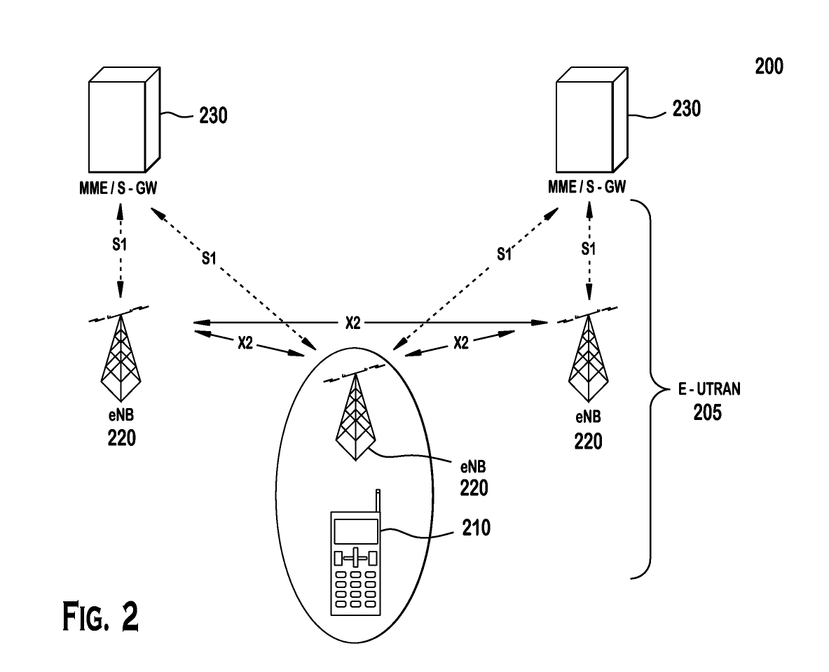

FIG. 2 shows an example LTE wireless communication system/access network 200 that includes an Evolved-Universal Terrestrial Radio Access Network (E-UTRAN) 205. The E-UTRAN 205 includes a WTRU 210 (i.e., LTE-A WTRU) and several evolved Node-Bs, (eNBs) 220. The WTRU 210 is in communication with an eNB 220. The eNBs 220 interface with each other using an X2 interface. Each of the eNBs 220 interface with a Mobility Management Entity (MME)/Serving GateWay (S-GW) 230 through an S1 interface. Although a single WTRU 210 and three eNBs 220 are shown in FIG. 2, it should be apparent that any combination of wireless and wired devices may be included in the wireless communication system access network 200.

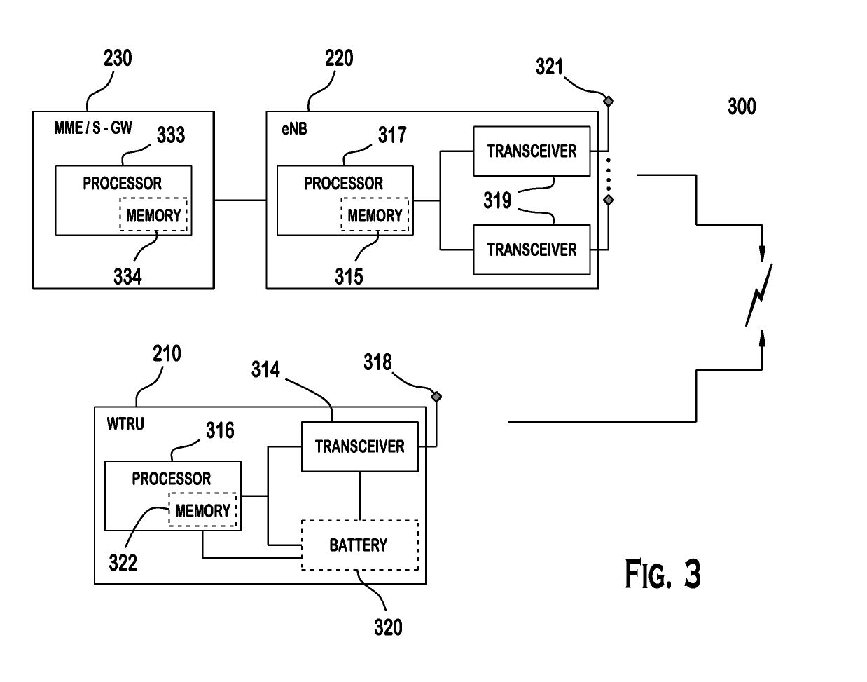

FIG. 3 is an example block diagram of an LTE wireless communication system 300 including the WTRU 210 (i.e., LTE-A WTRU), the eNB 220, and the MME/S-GW 230. As shown in FIG. 3, the WTRU 210, the eNB 220 and the MME/S-GW 230 are configured to perform a method of supporting carrier aggregation of multiple component carriers.

The WTRU 210 includes a processor 316 with an optional linked memory 322, at least one transceiver 314, an optional battery 320, an antenna 318, and other components (not shown) that may be found in a typical WTRU. The processor 316 is configured to perform, either alone or in association with software, a method of supporting carrier aggregation of multiple component carriers. The transceiver 314 is in communication with the processor 316 and the antenna 318 to facilitate the transmission and reception of wireless communications. The transceiver 314 may be configured to transmit and/or receive via multiple carriers simultaneously. Alternatively, the WTRU 210 may include multiple transceivers for simultaneous transmission and/or reception via multiple carriers. In case a battery 320 is used in the WTRU 210, it powers the transceiver 314 and the processor 316.

The eNB 220 includes a processor 317 with an optional linked memory 315, transceivers 319, an antenna 321, and other components (not shown) that may be found in a typical base station. The processor 317 is configured to perform a method of supporting carrier aggregation of multiple component carriers. The transceivers 319 are in communication with the processor 317 and the antenna 321 to facilitate the transmission and reception of wireless communications. The eNB 220 may include multiple transceivers for simultaneous transmission and/or reception via multiple carriers. Alternatively, the eNB 220 may include one transceiver configured to transmit and/or receive via multiple carriers simultaneously. The eNB 220 is connected to the Mobility Management Entity/Serving GateWay (MME/S-GW) 230 which includes a processor 333 with an optional linked memory 334.

In accordance with one embodiment, given that a cell, (e.g., an LTE-A cell), is configured with multiple component carriers, different usages may be allocated for the component carriers based on the radio resource management and the network traffic load conditions. The component carriers may be categorized as an anchor carrier or a data carrier.

The anchor carrier may be a component carrier that is assigned for cell search and synchronization. A WTRU, (e.g., an LTE-A WTRU), performs cell search and synchronization via the anchor carrier. The WTRU camps on the anchor carrier while in an idle state such that the anchor carrier serves the WTRU for most or all of its idle mode activities. The data carrier is used for higher throughput user data traffic by the cell when the WTRU is in a connected state with the network.

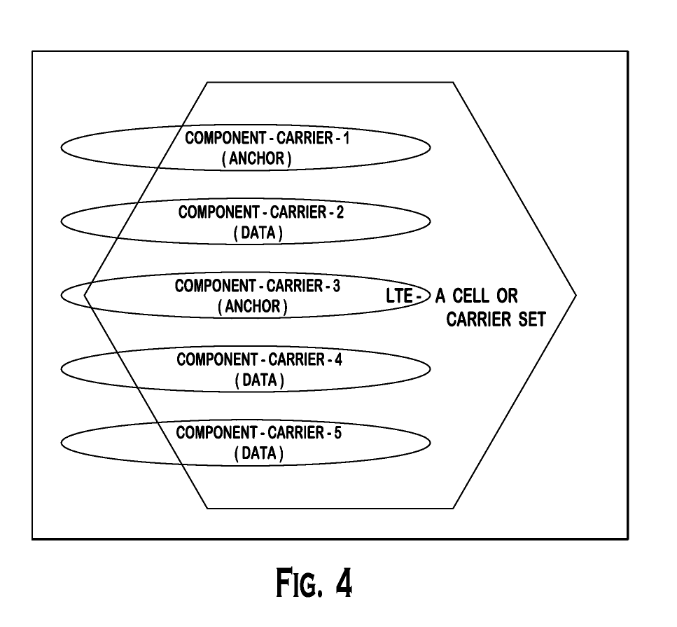

FIG. 4 shows component carriers configured as either an anchor carrier or a data carrier in accordance with one embodiment. In a cell with N component carriers, one or more component carrier(s) may be configured as an anchor carrier(s). The cell system resources, (i.e., component carriers), may be configured based on the radio resource management (RRM) and the network traffic conditions. In the example shown in FIG. 4, two component carriers are configured as an anchor carrier and three component carriers are configured as a data carrier. The anchor carriers may be mostly configured for the downlink. However, the system may also have an uplink component carrier configured as an anchor carrier, for example, for random access or other usages.

In accordance with one embodiment, an UL anchor carrier may be paired with a DL anchor carrier. The UL and DL anchor carrier pair may be symmetric so that one UL anchor carrier is paired with one DL anchor carrier. Alternatively, the UL and DL anchor carrier pair may be asymmetric (for example, due to the possible asymmetric DL/UL multiple component carrier configuration of an LTE-A cell), such that two or more DL anchor carriers may be associated with one UL anchor carrier in a cell.

More than one DL component carriers may be configured as a DL anchor carrier and more than one UL component carriers may be configured as an UL anchor carrier. The number of UL anchor carriers for the cell may be determined, for example, based on the uplink random access demand resulting from the initial access, the connection reestablishment, and/or the inbound handover activities, etc.

An anchor carrier may be configured to handle most or all of the WTRU idle mode operations so that WTRUs do not have to monitor or interact with the whole multi-carrier cell in an idle mode.

The downlink anchor carrier may include a synchronization channel (or resource elements) to facilitate the WTRU cell search, cell synchronization, and/or camping on the anchor carrier for the cell. The downlink anchor carrier may also include a broadcast channel, (e.g., physical broadcast channel (PBCH) and downlink shared channel (DL-SCH) or equivalent), that broadcasts all system information or at least the most important system information. The downlink anchor carrier may also include a paging channel, (e.g., a channel or paging mechanism built on top of the physical downlink control channel (PDCCH) and the downlink shared channel (DL-SCH), or equivalent), for incoming calls to the WTRUs. One or more initial random access channel(s) may be included in the uplink anchor carrier and a corresponding random access response mechanism may be implemented in the downlink anchor carrier. The anchor carrier may also include other layer 1/2 (L1/2) control channel(s) to transmit control information for data transmission and reception operation, such as a channel equivalent to the LTE physical control formation indicator channel (PCFICH) and the physical hybrid-ARQ indicator channel (PHICH), in the downlink and the physical uplink control channel (PUCCH) and the physical uplink shared channel (PUSCH) in the uplink. The anchor carrier may also include other channel or facilities for a WTRU camping on the cell and operating in an idle mode, such as multimedia broadcast multicast services (MBMS) channel or facilities.

A WTRU may initially camp on any anchor carrier of the cell through cell search as long as the cell and/or the anchor carrier is not barred or reserved and the public land mobile network (PLMN) check succeeds. A PLMN check is a network identification check. A wireless cell usually belongs to a particular PLMN. The PLMN check is performed to determine if the WTRU can operate in a cell in the detected PLMN. Alternatively, after detecting a plurality of anchor carriers of a cell, the WTRU may choose one of the detected anchor carriers. For example, the WTRU may select or reselect an anchor carrier based on its WTRU-ID (e.g., international mobile subscriber identity (IMSI)) as follows:

Chosen-anchor-carrier-index=IMSI mod the-num-of-anchor-carriers-in-the-cell.

In an idle state, the WTRU accesses and interacts with the cell only over the anchor carrier it camps on. The network (or the Advanced E-NB) may reassign or reallocate the WTRU to a different anchor carrier within the cell, for example, via an indication in system information or a connection release message. The connection release message may be used to put the WTRU into an idle mode from their connected state at the end of the WTRU network connection.

A WTRU may read the most important system information from the camped-on anchor carrier. By reading the most important system information, the WTRU may obtain information for further acquiring the rest of the system information, (e.g., specific component carrier, resource unit, and timing via the cell's parameter cross-carrier-SysInfo-location). The specified location for the rest of the system information, which is for all WTRUs camped on the cell over all different anchor carriers, may or may not be in the same anchor carrier.

An idle mode WTRU may monitor the paging channel on the anchor carrier that the WTRU is camping on. Discontinuous reception (DRX) and paging occasion may be configured for the WTRU on the anchor carrier. The paging configuration may be the same across all anchor carriers, or the paging configuration may be anchor carrier specific. The cell (or the Advanced E-NB or the E-NB controller) knows which anchor carrier the WTRU is assigned to and pages for the WTRU over that specific anchor carrier only.

Embodiments for broadcasting the master information block (MIB) and the system information blocks (SIBs) are explained hereafter. There may be two kinds of MIB: LTE compatible MIB for both LTE WTRUs (more generally WTRUs that are not capable of multi-carrier operation) and LTE-A WTRUs (more generally WTRUs that are capable of multi-carrier operation), and LTE non-compatible MIB for carrying LTE-A-specific information for LTE-A WTRUs. Similarly, there may be two kinds of SIBs: LTE compatible SIBs for both LTE WTRUs and LTE-A WTRUs, and LTE non-compatible SIBs for carrying LTE-A-specific information for LTE-A WTRUs. It should be noted that even though the embodiments are described with reference to LTE and LTE-A, the embodiments may be applied to any multi-carrier operations and systems.

In accordance with one embodiment, all the essential system information for cell access and idle mode operation is broadcast on the anchor carrier, while connected mode operation-related system information is either broadcast on the same anchor carrier or broadcast on the cell level via a component carrier indicated by a parameter, for example, “cross-carrier-SysInfo-location.” The WTRU in an idle mode may monitor the anchor carrier for system information and its change.

In accordance with this embodiment, each anchor carrier may broadcast the MIB, Level-1 system information and the system information necessary for LTE-A WTRU idle mode operations. LTE-A WTRUs in an idle mode do not need to read system information for the connected mode operations until it is brought into the RRC connected state. Detailed information elements that are included in the MIB, the Level-1 system information and system information necessary for idle mode operations are explained below.

The MIB may include at least one of (1) the system frame number (i.e., the most significant bits (MSBs) of system frame number (SFN)) for the LTE-A cell, (2) the bandwidth of the cell (or the number of the component carriers) in the DL and UL and other per cell information, such as the cell identity, (3) per component carrier information including, but not limited to, carrier frequency (e.g., evolved absolute radio frequency channel number (EARFCN) and range or center frequency), an uplink and downlink anchor and data carrier mark, an LTE-A anchor carrier and LTE cell co-location mark, and anchor carrier-specific information such as uplink downlink anchor carrier mapping information, a camping allowed indicator, etc, or (4) hardware-specific information for the LTE-A cell, such as MIMO or antenna information or other information specific to the LTE-A cell or to the LTE-A anchor carrier, and the like.

The MIB may optionally include information for facilitating the fast cell selection decision making including, but not limited to, at least one of (1) a PLMN list and a location or tracking area code, (2) cell access restriction information, access class information, and cell selection information (e.g., the minimum level signal strength indicator), (3) the other broadcast channel access information if configuration information is required, or (4) scheduling information for other SIBs acquisition, and the like. With this information, all the necessary cell reselection decision making information may be obtained from the MIB in one system information acquisition.

The Level-1 system information block may include, but is not limited to, at least one of (1) PLMN-IDs and a location/tracking area code (if not included in the MIB), (2) scheduling information to obtain all other SIBs which are broadcast on the address and time defined by the cell (if not included in the MIB), (3) cell access restriction information such as an indicator indicating that the cell is barred, access-class control information, intra-cell-band reselection indicator and timer (if not included in the MIB), (4) cell selection information such as minimum signal strength indicators (if not included in the MIB), or (5) the network or non-access stratum (NAS) system information for the cell (e.g., the location area and the core network), and the like.

The system information for idle mode operations includes, but is not limited to, at least one of (1) random access channel configuration in the uplink anchor carrier and the random access response channel configuration in the downlink of the camped anchor carrier and the L1/2 control channel access information if needed for random access in LTE-A, (2) paging reception channel configuration including the monitoring DRX cycle and paging occasion calculation parameters and the L1/2 control channel access information if needed for paging reception in LTE-A, (3) cell reselection information including signal strength offsets to start reselection measurements (for intra-cell carrier, intra-frequency, inter-frequency and inter-RAT) and speed dependent scaling factors and offsets, (4) various neighbor cell list for cell reselection for targeted cell reselection measurements and their network assigned reselection priorities, or (5) parameter information on WTRU-assisted self-organizing network (SON), automatic neighbor relations (ANR), or relay functionalities, and the like.

Whether the information elements listed above belong to one or more system information blocks depends on the broadcast channel bandwidth and the WTRU operation with respect to the system information acquisition latency. The listed information elements may be assigned to one or more information blocks in any order and in any combinations.

In accordance with another embodiment, only the most essential system information for cell access and scheduling information for acquiring the rest of the system information may be broadcast via the anchor carrier, while all the rest of the system information may be broadcast on the cell level via another component carrier indicated by a parameter, for example, the cross-carrier-SysInfo-location. Each anchor carrier may broadcast the MIB and the Level-1 system information listed above and scheduling information for obtaining other SIBs. The LTE-A WTRU obtains the system information necessary for the idle mode operations via the anchor component carrier. With this embodiment, the per anchor carrier overhead is minimized.

It should be noted that the assignment of MIB, level-1 SIB or SIBs necessary for idle mode operations to the anchor carrier may be dependent on the broadcast facilities devised for the LTE-A, and the information allocated to the anchor carrier may be only MIB, MIB and one SIB, or MIB and more than one SIBs, and the MIB and SIBs may be on the same channel or different channels.

The LTE-A anchor carrier may be co-located with an LTE cell (i.e., LTE carrier). In this case, the LTE carrier bandwidth overlaps the LTE-A component carrier bandwidth (e.g., 20 MHz). For Rel-8 LTE backward compatibility, the overlapped component carrier may be accessible by both LTE WTRUs and LTE-A WTRUs, and will serve for both the LTE-A operations and the LTE operations. An LTE WTRU may process one of the component carriers while an LTE-A WTRU may process multiple component carriers simultaneously including the overlapped component carrier. If a component carrier is accessible by both the LTE WTRU and the LTE-A WTRU, the control signaling, reference signal, or the like should be LTE-8 backward compatible. Therefore, when the network deploys an LTE cell together with an LTE-A anchor carrier, the LTE cell configuration takes precedence. The LTE cell configuration assumes its usual configuration (such as the center frequency 72 sub-carriers) essential for LTE cell operation. Other subcarriers and resources not taken by the LTE cell operation in the anchor carrier may be allocated for the LTE-A anchor carrier operation.

Information to identify the co-located carrier may be embedded to the cell synchronization mechanism, so that the LTE-A WTRU would know it is a co-located carrier. An LTE WTRU does not need to know since the resources for the LTE operations are in the same configuration.

Alternatively, the LTE-A MIB or an indication may be broadcast via the same physical broadcast channel (PBCH) as in the LTE MIB with the first part of the LTE-A content is same to the LTE MIB with an additional bit. The additional bit may indicate that the LTE-A anchor carrier and the LTE carrier are co-located.

Alternatively, the LTE-A specific MIB and SIBs may be included in a known and fixed location and time, which are different from the LTE PBCH location and time, so that the LTE-A WTRU, after reading the additional bit, may read the LTE-A MIB and SIBs from the fixed location in the same carrier and scheduled time whenever the LTE-A WTRU camps on an LTE-A anchor carrier.

Alternatively, an LTE-A WTRU that reads this additional bit may switch to a configured other place, (i.e., another component carrier), for obtaining the rest of the LTE-A MIB contents and system information elements. In this case, the MIB and SIB contents for LTE-A anchor carrier may need to be kept to a minimum.

If an LTE-A data carrier and an LTE cell (i.e., carrier) are co-located, the LTE cell configuration and operation takes precedence, and the LTE-A data carrier operations may be limited to the radio resources that do not affect the LTE cell operations.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

What is claimed is:

1. A method for supporting aggregation of multiple component carriers, the method comprising:
a wireless transmit/receive unit (WTRU), performing a cell search to detect a downlink anchor carrier, the downlink anchor carrier being a component carrier assigned for synchronization and idle mode operations for the WTRU;
the WTRU, in an idle state, camping on the downlink anchor carrier; and
the WTRU via the downlink anchor carrier, and while in the idle state, receiving a broadcast channel for a broadcast message, a paging channel for a paging message, and a control channel for control information.

2. The method of claim 1 further comprising:
the WTRU switching to a connected state and receiving data via an aggregated carrier comprising at least two component carriers including a data carrier, the data carrier being a component carrier assigned for data transfer to the WTRU.

3. The method of claim 1 further comprising:
the WTRU transmitting a random access message via an uplink anchor carrier, and receiving a random access response message via the downlink anchor carrier.

4. The method of claim 1 wherein the WTRU selecting a detected downlink anchor carrier based on a WTRU identity.

5. The method of claim 1 wherein the WTRU receives necessary system information for cell access and idle mode operation via the downlink anchor carrier, including system information for connected mode operation.

6. The method of claim 1 wherein the WTRU receives necessary system information for cell access and idle mode operation via the downlink anchor carrier, and receives necessary system information for connected mode operation via another component carrier.

7. The method of claim 1 wherein the WTRU receives necessary system information for cell access and scheduling information for acquiring further system information via the downlink anchor carrier and receives necessary system information for idle mode operation and connected mode operation via another component carrier.

8. The method of claim 1 further comprising:
the WTRU receiving an indication that the downlink anchor carrier is accessible by a WTRU that does not have a capability of processing multiple component carriers simultaneously.

9. The method of claim 8 wherein the WTRU receives a master information block (MIB) that is intended for both a WTRU having a carrier aggregation capability and a WTRU not having a carrier aggregation capability along with the indication, and separately receives an MIB or MIB extension for carrier aggregation operation.

10. The method of claim 8 wherein the WTRU receives a master information block (MIB) for carrier aggregation operation in a fixed location and scheduling that are different from a location and scheduling for an MIB intended for a WTRU not having a carrier aggregation capability.

11. A wireless transmit/receive unit (WTRU) for supporting aggregation of multiple component carriers, the WTRU comprising:
a transceiver configured to transmit and receive via an aggregated carrier comprising at least two component carriers; and
a processor configured to perform a cell search to detect a downlink anchor carrier and camp on the downlink anchor carrier in an idle state, and receive via the downlink anchor carrier a broadcast channel for a broadcast message, a paging channel for a paging message, and a control channel for control information, the downlink anchor carrier being a component carrier assigned for synchronization and idle mode operations for the WTRU.

12. The WTRU of claim 11 wherein the processor is configured to switch to a connected state and receive data via an aggregated carrier comprising at least two component carriers including a data carrier, the data carrier being a component carrier assigned for data transfer to the WTRU.

13. The WTRU of claim 11 wherein the processor is configured to transmit a random access message via an uplink anchor carrier, and receive a random access response message via the downlink anchor carrier.

14. The WTRU of claim 11 wherein the processor is configured to select a detected downlink anchor carrier based on a WTRU identity.

15. The WTRU of claim 11 wherein the processor is configured to receive system information necessary for cell access and idle mode operation via the downlink anchor carrier, including system information for connected mode operation.

16. The WTRU of claim 11 wherein the processor is configured to receive system information necessary for cell access and idle mode operation via the downlink anchor carrier, and receive system information for connected mode operation via another component carrier.

17. The WTRU of claim 11 wherein the processor is configured to receive system necessary for cell access and scheduling information for acquiring further system information via the downlink anchor carrier and receive system information necessary for idle mode operation and connected mode operation via another component carrier.

18. The WTRU of claim 11 wherein the processor is configured to receive an indication that the downlink anchor carrier is accessible by a WTRU that does not have a capability of processing multiple component carriers simultaneously.

19. The WTRU of claim 18 wherein the processor is configured to receive a master information block (MIB) that is intended for both a WTRU having a carrier aggregation capability and a WTRU not having a carrier aggregation capability along with the indication, and separately receive an MIB for carrier aggregation operation.

20. The WTRU of claim 18 wherein the processor is configured to receive a master information block (MIB) for carrier aggregation operation in a fixed location and scheduling that are different from a location and scheduling for an MIB intended for a WTRU not having a carrier aggregation capability.

21. A method for supporting aggregation of multiple component carriers, the method comprising:
transmitting system information necessary for cell access and idle mode operation via a downlink anchor carrier, the downlink anchor carrier being a component carrier assigned for synchronization and idle mode operations for a wireless transmit/receive unit (WTRU), the downlink anchor carrier including a broadcast channel for a broadcast message, a paging channel for a paging message, and a control channel for control information necessary while in an idle state; and
transmitting data via an aggregated carrier comprising at least two component carriers including a data carrier, the data carrier being a component carrier assigned for data transfer to a WTRU in a connected state.

22. The method of claim 21 further comprising:
sending an indication that the downlink anchor carrier is accessible by a WTRU that does not have a capability of processing multiple component carriers simultaneously.

23. The method of claim 22 further comprising:
transmitting a master information block (MIB) that is intended for both a WTRU having a carrier aggregation capability and a WTRU not having a carrier aggregation capability along with the indication, and separately transmitting an MIB for carrier aggregation operation.

24. The method of claim 22 wherein a master information block (MIB) for carrier aggregation operation is transmitted in a fixed location and scheduling that are different from a location and scheduling for an MIB intended for a WTRU not having a carrier aggregation capability.

25. An apparatus for supporting aggregation of multiple component carriers, the apparatus comprising:
a transceiver configured to transmit and receive via an aggregated carrier comprising at least two component carriers; and
a processor configured to transmit system information necessary for cell access and idle mode operation via a downlink anchor carrier, and transmit data via an aggregated carrier comprising at least two component carriers including a data carrier, the downlink anchor carrier being a component carrier assigned for synchronization and idle mode operations for a wireless transmit/receive unit (WTRU), the downlink anchor carrier including a broadcast channel for a broadcast message, a paging channel for a paging message, and a control channel for control information necessary while in an idle state, and the data carrier being a component carrier assigned for data transfer to a WTRU in a connected state.

26. The apparatus of claim 25 wherein the processor is configured to send an indication that an individual component carrier of the aggregated carrier is accessible by a WTRU that does not have a capability of processing multiple component carriers simultaneously.

27. The apparatus of claim 26 wherein the processor is configured to transmit a master information block (MIB) that is intended for both a WTRU having a carrier aggregation capability and a WTRU not having a carrier aggregation capability along with the indication, and separately transmit an MIB for carrier aggregation operation.

28. The apparatus of claim 26 wherein the processor is configured to transmit a master information block (MIB) for carrier aggregation operation in a fixed location and scheduling that are different from a location and scheduling for an MIB intended for a WTRU not having a carrier aggregation capability.
